(19) United States
(12) Patent Application Publication
(10) Pub. No.: US 2014/0138293 A1
(43) Pub. Date: May 22, 2014

(54) Novelty Pool Maintenance Article Support Float and Article Retainer

(71) Applicants: Barbara Tackett, Baytown, TX (US); Robert M. Barksdale, Baytown, TX (US); Lucas Tackett, Baytown, TX (US); Crystal Tackett, La Porte, TX (US)

(72) Inventors: Barbara Tackett, Baytown, TX (US); Robert M. Barksdale, Baytown, TX (US); Lucas Tackett, Baytown, TX (US); Crystal Tackett, La Porte, TX (US)

(21) Appl. No.: 14/083,791

(22) Filed: Nov. 19, 2013

Related U.S. Application Data
(60) Provisional application No. 61/728,438, filed on Nov. 20, 2012.

(51) Int. Cl. C02F 1/68

(52) U.S. Cl. CPC C02F 1/688
USPC 210/85

(57) ABSTRACT

A novelty pool float device is provided for supporting a pool chlorine dispenser, a pool thermometer, and for providing storage of articles within the float device along the water's surface. The device comprises a float body having an ornamental shape and design that resembles an animal creature, such as an alligator, duck, or deer, while the body underside surface includes a first and second threaded aperture to accept the chlorine dispenser and thermometer upper therein. Within the float body is an aperture for storing articles such as other pool maintenance items (pH test strips, etc.) and personal items of those in the pool. The float body is weighted to support the chlorine dispenser and thermometer in an upright configuration that resists tipping, particularly in choppy conditions when participants are in the water.

### CROSS REFERENCE TO RELATED APPLICATION

This application claims the benefit of U.S. Provisional Application No. 61/728,438 filed on Nov. 20, 2012, entitled “Wildlife Supplies for Pools Hot Tubs and Spas.” The above identified patent application is herein incorporated by reference in its entirety to provide continuity of disclosure.

### BACKGROUND OF THE INVENTION

1. Field of the Invention

The present invention relates to pool floats and novelty support items. More specifically, the present invention pertains to a pool float that supports a pool chemical dispenser and thermometer along the surface of pool water, wherein a decorative shape is visualized above the water to give the impression of a floating animal while also offering functionality in the way of tool attachment and article support thereon.

Residential pools are high maintenance items that require owners to monitor, clean, and regulate the water and the surrounding areas to ensure proper conditions are met for usage and such that the water remains clear and appealing. Many techniques are employed for these purposes, including physical pool surface cleaners (e.g. vacuums, scrubbers, etc.), chemical treatments (e.g. salt tablets, chlorine tablets, etc.), and various covers and barriers for maintenance and safety.

For those owners who choose to chlorinate their pool water, it is common to employ floating chlorine dispensers in the pool water. This reduces the owner's duties with respect to manually dispensing chlorine tablets in the water over a period of time, as the dispensers generally float along the surface of the water and dispense chlorine through its structure over a given interval. The chlorine reacts with the pool water to create chemicals that prevent bacteria growth in the water, maintaining its cleanliness and clarity.

When using chlorine, it is important to monitor the chemical and physical properties of the water to ensure continued safe use by children, adults, and pets, and also to ensure the water is being chemically treated correctly. A common means of chemically testing the water is to test its acidity, or pH levels. Along with monitoring pH levels within a chlorinated pool, many owners monitor the temperature of the water using a thermometer or thermocouple device. Along with acidity, temperature monitoring allows the owner to check the conditions of the water throughout the season for the purposes of determining how comfortable the pool is to swim in, given the outside air temperature.

When treating and monitoring the water throughout the pool's season, it is not uncommon for the surrounding area to become cluttered with cleaning devices and pool monitoring items. This can be a nuisance when multiple products are in the way while of those in the pool attempting to enjoy themselves and relax. Some items may be stored outside of the pool, while others are adapted to be placed in the pool water itself for long-term use and treatment of the water. These in-pool and exterior pool items can disrupt the aesthetics of the water and the adjacent area, and may also expose those in the pool to unexpected with these items (pool floats, skimmers, vacuums, etc.) while swimming

The present invention pertains to a new and novel pool float and organization device, where a pool float is provided that comprises a novelty float body having a unique shape and appearance, and a structure that provides support for a chlorine dispenser, a pool thermometer, and also provides for storage of articles within its body structure. The body design is adapted to give users the appearance of an animal or object in the water, while the device functions as a buoyant support for pool monitoring and maintenance items. Overall, the float provides a decorative and functional device for pools and hot tubs.

2. Description of the Prior Art

Devices have been disclosed in the prior art that relate to pool float devices and chlorine dispensers. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

The first set of prior art patents pertains to floating chlorine dispensers having structures that facilitate replenishing of the chlorine tablets, notifying a user that the device is depleted of tablets, and improving the operation of the float in various ways. These devices are well suited for dispensing chlorine tablets in a pool over a period of time and with minimal supervision; however, they are distinguished from the present invention in that herein is provided a novelty chlorine dispensers float that also supports a thermometer and other items within its structure. The present invention is directed to an ornamental float upper having a base that accepts a threaded chlorine dispenser and thermometer, while along the upper portion thereof is an article retainer for various pool supplies or personal articles of individuals actively in the pool.

One such float device is U.S. Pat. No. 5,795,551 to Powell, which discloses a floating chemical chlorine dispenser for swimming pools, wherein the device includes an inlet port and outlet port for delaying the distribution of chlorinating chemicals into the pool water for extended duration between maintenance thereof. A dissolvable plug blocks the outlet port, which dissolves over time in the water and starts the chlorination process. The device effectively delays the chlorination process if the user leaves the pool unattended for periods of time. While effective as a means of chlorinating a pool after a given time, the Powell float does not support a floating chlorinator and thermometer, while providing a novelty float design and a means of storing items therein.

Another device is U.S. Pat. No. 4,825,528 to Nicholson, which provides a floating chlorine dispenser that continuously dispenses chlorine into pool water for a given period of time. The device includes a water line demarcation defined by a first and second color, wherein the user can visualize when the chlorine in the float needs to be refreshed if the bottom color rises above the water level. Similar to the Powell device, the Nicholson device describes a chlorine float structure that does not add any ornamental accessories to a pool or assist in uncluttering the same.

Finally, U.S. Pat. No. 4,828,804 to Nicholson similarly describes a chlorine float device for a pool, wherein this device includes a tethered construction to limit prevent the float from being trapped in one general pool location based on the water currents in the pool. As distinguished from a freely floating device, the '804 Nicholson device includes a tether that attaches to a retainer along the side of the pool to prevent the float from being trapped in a corner of the pool by the pool's natural current.

A second set prior art devices relate to purely ornamental float tops for chlorine dispensers. These devices include a specific design for the upper float, wherein the design is ornamental and lacks functionality beyond buoyancy, while supporting the chlorinator structure therebelow.

Devices such as these include U.S. Design Pat. No. D510,404 to Thompson, U.S. Design Pat. No. D461,871 to Flowers, and U.S. Design Pat. No. D275,311 to Wolfe. These devices describe ornamental float shapes that resemble athletic equipment and various animals. However, the primary limitation to these devices is that they fail to provide a floating top that supports both a chlorinator and thermometer, while also offering storage space for other articles or a location to support items thereon along the pool surface.

The present invention provides owners with a novelty float item that supports multiple pool maintenance items, improving the pool's appearance, providing a novelty item for conversation, and for removing loose clutter within the pool water. It is submitted that the present invention is substantially divergent in design elements from the prior art, and consequently it is clear that there is a need in the art for an improvement to existing pool float devices. In this regard the instant invention substantially fulfills these needs.

### SUMMARY OF THE INVENTION

In view of the foregoing disadvantages inherent in the known types of pool float devices now present in the prior art, the present invention provides a new float that can be utilized for providing convenience for the user when supporting and organizing pool maintenance equipment within the pool water while offering an ornamentally designed float upper for user enjoyment and novelty purposes.

It is therefore an object of the present invention to provide a new and improved pool float device that has all of the advantages of the prior art and none of the disadvantages.

It is another object of the present invention to provide a pool float device that supports both a chlorine dispenser device and a pool thermometer along the pool surface, wherein the tools are placed at a given distance apart and not free to float in the pool by themselves.

Another object of the present invention is to provide a pool float device that includes a float body that is adapted to remain upright while floating and is sufficiently buoyant that the float will not sink or flip while deployed in connection with a chlorine dispenser and thermometer.

Yet another object of the present invention is to provide a pool float device that includes a float body having an internal cavity for support of articles therein, including pool maintenance or inspective items and pool participants' personal items.

Another object of the present invention is to provide a pool float device that includes a float body that includes a decorative float body that resembles an object or animal in the water for novelty purposes.

A final object of the present invention is to provide a pool float device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of an exemplary embodiment of the present invention, where the pool float body is in the shape of an alligator head.

FIG. 2 shows an underside perspective view of the exemplary embodiment of the present invention, along with an exploded view of the chlorine dispenser and thermometer and their respective connections with the float body.

FIG. 3 shows a view of an embodiment of the pool float, wherein a deer shape is provided.

FIG. 4 shows yet another embodiment of the pool float, wherein a duck shape is provided.

### DETAILED DESCRIPTION OF THE INVENTION

Reference is made herein to the attached drawings. Like reference numerals are used throughout the drawings to depict like or similar elements of the pool float device. For the purposes of presenting a brief and clear description of the present invention, the preferred embodiment will be discussed as used for supporting a chlorine dispenser and pool thermometer device while offering storage space within a buoyant structure. The figures are intended for representative purposes only and should not be considered to be limiting in any respect.

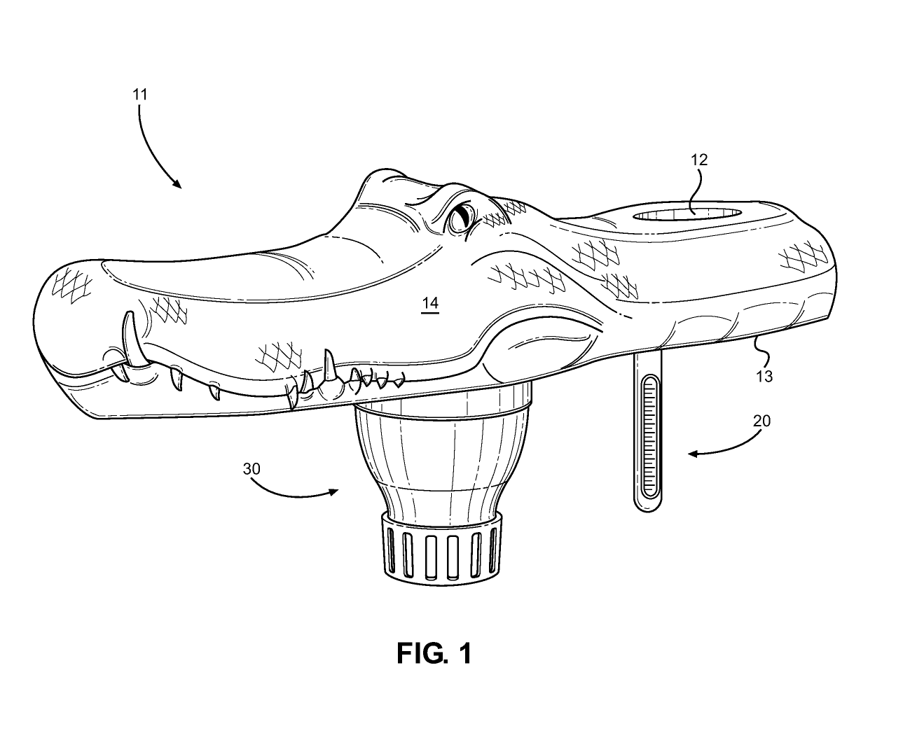

Referring now to FIG. 1, there is shown a view of an exemplary embodiment of the pool float device of the present invention. The device comprises a float body 11 having an upper surface 14 design and shape and a flat underside surface 13. The upper surface 14 is adapted to form a unique shape that resembles an animal, wherein the device when in the water will be a novelty item that makes the float look like an animal in the water. The float body 11 is buoyant and its center of mass is such that it resists tipping while in the water, particularly when supporting to a chlorine dispenser 30 and pool thermometer 20.

Along the flat underside surface 13 of the float body 11 is a first and second attachment for a pool chlorine dispenser device 30 and a pool thermometer 20, which are adapted to connect along their upper edges and be suspended in the water from the float body 11 thereabove. The float body 11 remains along the surface of the water and supports the chlorine dispenser 30 and thermometer 20 below the surface of the water for proper operation thereof.

Disposed along the float body is a cavity 12 that is adapted to support articles within the float interior. The cavity 12 is preferably positioned along the upper surface thereof such that water does not freely fill the cavity interior. When deployed, the cavity 12 operates as a storage means for storing pH test strips and other pool maintenance items, or alternatively provides a location for a user to rest personal items or refreshment items therein while in the pool. The float body 11 therefore supports the underlying pool maintenance items, along with personal items stored within the upper portion of the float body 11.

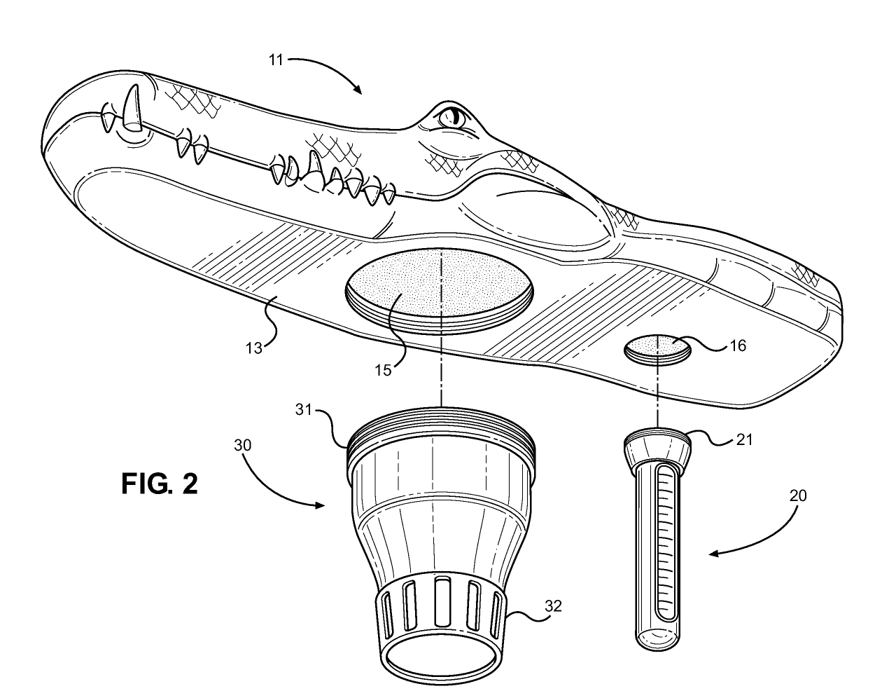

Referring now to FIG. 2, there is shown an underside perspective view of the float body 11 and its connection with the chlorine dispenser 30 and pool thermometer 20. Disposed along the underside surface 13 of the float body 11 is a first 15 and second 16 aperture that are adapted to accept the upper portions of the dispenser 30 and thermometer 20 devices. The apertures 15, 16 comprises threaded interior sidewalls that are adapted to mate with corresponding male threads along the upper portions 31, 21 of the dispenser and thermometer. Applying the two involves threadably attaching the articles to apertures of the float body, whereafter the assembly can be deployed in the water for dispensing chlorine therein and monitoring the temperature thereof.

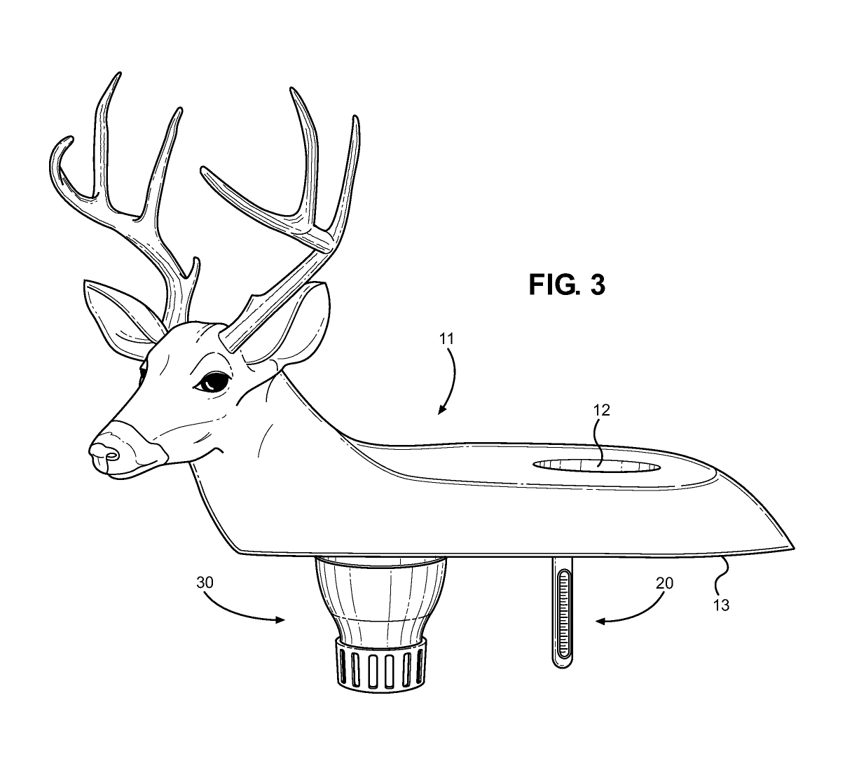

Referring now to FIG. 3, there is shown a perspective view of an embodiment of the float body 11, wherein the device is in the shape of a deer. In this embodiment, the float body 11 includes the head of a deer and its back, forming a buoyant structure that resembles a floating deer within the water when deployed. A cavity 12 is disposed along the body 11 that allows for storage, while the underside surface 13 is similar to that of the alligator float body embodiment: flat and having a first and second aperture to accept the threaded upper of a chlorine dispenser and pool thermometer. The deer embodiment, similar to all designs of the float body, is buoyant and balanced such that the device does not readily tip over when placed into the water, and in particular when attached to the chlorine dispenser and thermometer devices.

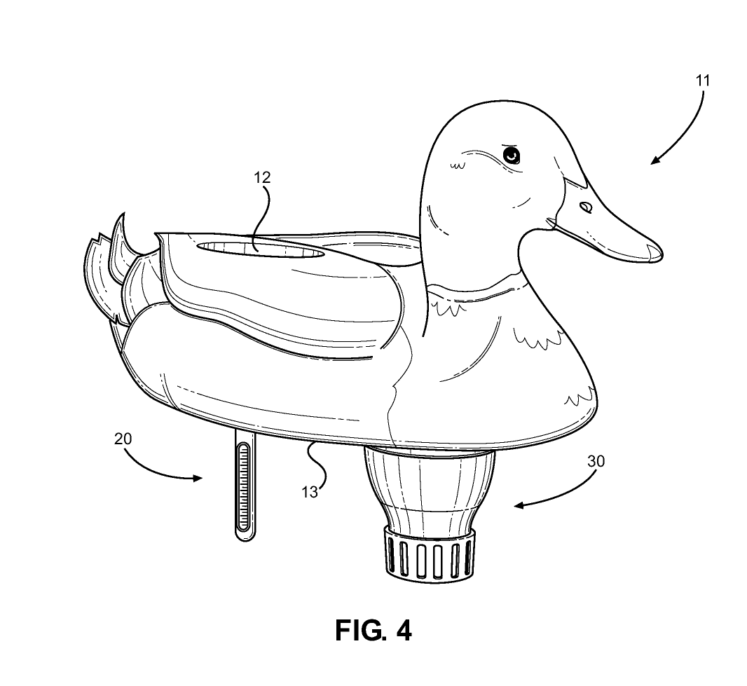

Referring finally to FIG. 4, there is shown another embodiment of the float body 11. In this embodiment, the float body 11 comprises the shape of a duck, wherein the upper surface thereof forms a duck head, tucked wings, and extended feathers. The underside surface 13 is relatively flat to threadably attach the chlorine dispenser 30 and thermometer 30 devices thereto.

The present invention contemplates a pool float and pool chlorine dispenser/thermometer support device that has a body portion in the shape of an animal, whereby the float resembles a floating animal in the water for novelty purposes. The body portion is preferably a foam material or similar float material that is buoyant and balanced, whereby the additional attachments below the float do not cause an imbalance of the float such that the device remains stable while in the water. The exact shape, color, and design of the float body may take on several forms, falling within the scope of providing a substantially flat underside surface, apertures for supporting the dispenser and thermometer, and an upper cavity for supporting other articles therein.

Typical residential pools or hot tubs may quickly become cluttered with thermometers, cleaning devices and other necessary items over a period of use. It can be a nuisance when multiple products are visible or in the path of swimming pool users who are otherwise in the pool to have a fun, enjoyable and relaxing time swimming therein. These items can disrupt the aesthetics of the area, and may lead to the same being misplaced or damaged if not attended to.

The present invention describes a pool float and pool maintenance article support, wherein a chlorine dispenser and thermometer are supported therefrom. The device comprises an attachment for the top of a floating pool chemical dispenser that includes raised threads. The threads allow for the interchangeable attachment of various styles of float bodies with the chemical dispenser and thermometer device, wherein the float bodies take on different designs that are ornamental in nature and a novelty addition to one's pool. Overall, the present invention colocates a number of devices needed to maintain a pool, hot tub, or spa. When deployed, the float device resembles one of a wide range of different wildlife designs to add to the pool's aesthetic qualities.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A novelty pool maintenance article support float and article retainer, comprising:
a float body having an upper surface shape and design resembling a wildlife animal;
said float body further comprising a substantially flat underside surface;
said underside surface comprising a first and second aperture, said first aperture adapted to support the upper portion of a pool chemical dispenser, said second aperture adapted to support the upper portion of a pool thermometer device;
said float body further comprising a cavity therein, said cavity adapted for supporting articles therein;
said float body comprising a buoyant structure.

2) The device of claim 1, wherein said first and second apertures further comprise threaded apertures, wherein said threaded apertures are adapted to threadably attach to said pool chemical dispenser and said pool thermometer device.

3) The device of claim 1, wherein said float body cavity is disposed along said upper surface of said float.

4) The device of claim 1, wherein said float body upper surface shape and design further comprises an alligator head shape.

5) The device of claim 1, wherein said float body upper surface shape and design further comprises a deer head shape.

6) The device of claim 1, wherein said float body upper surface shape and design further comprises a duck shape.
